(19) United States
(12) Patent Application Publication
(10) Pub. No.: US 2008/0252150 A1
(43) Pub. Date: Oct. 16, 2008

(54) Linear Actuator in an Electric Percussion Tool

(75) Inventors: Andreas Grundl, Starnberg (DE); Bernhard Hoffmann, Starnberg (DE)

Correspondence Address: HISCOCK & BARCLAY, LLP, 2000 HSBC PLAZA, 100 Chestnut Street, ROCHESTER, NY, 14604-2404, US

(73) Assignee: Compact Dynamics GmbH, Starnberg (DE)

(21) Appl. No.: 11/911,635

(22) PCT Filed: Mar. 31, 2006
(86) PCT No.: PCT/EP2006/002969

§ 371 Date: Jun. 4, 2008

(30) Foreign Application Priority Data
Apr. 15, 2005 (DE) 10 2005 017 483.3

(51) Int. Cl. H02K 41/02

(52) U.S. Cl. 310/12

(57) ABSTRACT

A linear actuator in an electric percussion tool is equipped with a rotor and a stator, wherein the rotor has at least two stacks, which are arranged at a predetermined distance from one another, of superposed permanently magnetic bars, the stator is formed, at least partially, from a soft-magnetic material and has at least two pairs of teeth with mutually opposed teeth, of which each pair of teeth receives one of the two stacks between them, in each case, while forming an air gap, and wherein the stator has at least two magnetically conductive inner regions which are located between the two stacks, are arranged at a predetermined distance from one another in the direction of movement of the rotor and are at least partially surrounded, in each case, by an essentially hollow-cylindrical coil arrangement, the central longitudinal axis of which is oriented approximately transversely to the direction of movement of the rotor, and the rotor has a driving element which is able to transmit a mechanical impulse to a tool belonging to the electric percussion tool.

### CROSS-REFERENCE TO RELATED APPLICATIONS

This is a continuation of International Patent Application No. PCT/EP2006/002969, filed Mar. 31, 2006.

### BACKGROUND TO THE INVENTION

The present invention relates to a linear actuator in an electric percussion tool, which actuator is to be operated electrically and has a rotor and a stator, wherein the rotor is set up to act upon a tool belonging to the electric percussion tool. Areas of application for electric percussion hammers of this kind are, for example, overground and underground construction, the construction of installations, concrete works, artificial stone factories, foundries, installation companies, the processing of natural and artificial stone and of every type of masonry and concrete, caulking, chiseling, breaking-up, excavating, granulating, beating, tamping and deburring, the breaking-up of concrete and asphalt and also rubble-permeated ground, the demolition of concrete, masonry and other building materials, the tearing-up of roads and concrete, asphalt and tar and also wood-block and stone paving, the cutting of clay, loam, turf and also salts, the comminution of soils which have been compacted or stamped down, or the ramming-in of piles and earthing bars.

1. Prior Art

From working practice, breaking-up hammers are known in which an alternating-current universal motor drives a crank mechanism by means of a transmission after a manual switching lever has been actuated. The resulting rotating movement of a pin on the crank mechanism is converted into rectilinear movement with the aid of a connecting rod and a guide piston, and is passed on to a striking piston by means of an air cushion. Said striking piston then impinges directly upon a tool which is fitted to the breaking-up hammer and depends upon the intended use (a pointed, star-profile, flat, key-slot or boasting chisel, a spade, an asphalt-cutter, a stamping insert, a stamping ram, a pile helmet for ramming piles or a driving mandrel). A built-in electronic regulating system ensures a low switching-on current and a constant rotational speed of the driving motor.

From DE 10259566 A1, a percussive electric hand-held machine tool is known, in which a tool is struck along a striking axis by an electric motor, In this instance, the electric motor has a rotor shaft which is arranged transversely to the striking axis and has a bundle of rotor laminations and a motor pinion which drives a striking-mechanism subassembly with an eccentric via a striking-mechanism transmission. The bundle of rotor laminations is arranged in a manner which is completely diametrical to the striking-mechanism transmission with respect to the striking axis.

U.S. Pat. No. 1,871,446 indicates an electric hammer in which the stator coils are arranged in a row and form separate magnetic circuits which do not interact. Secondary coils which cooperate with the respective stator coils are provided in the rotor.

Specifications which indicate the technological background are U.S. Pat. No. 2,892,140, DE 10025 371 A1, DE 30 30 910 A1 and DE 102 04 8861 A1.

2. The Problem Underlying the Invention

With the relatively low weight of the electric percussion hammer, it is possible, only with difficulty, to achieve the striking power, individual impact energy and number of impacts required for many areas of application, for example operations for demolishing and breaking up concrete, masonry and stone, but also in medium and heavy wall-breaching operations demolitions and repair work in building redevelopment and the sanitation field, and also for ground-level demolitions and breaching operations. Moreover, known arrangements require a lot of construction space.

3. Solution According to the Invention

In order to eliminate these disadvantages, the invention teaches a linear actuator in an electric percussion tool, which actuator is to be operated electrically and is defined by the features in claim 1.

### CONSTRUCTION, FURTHER DEVELOPMENTS AND ADVANTAGES OF THE SOLUTION ACCORDING TO THE INVENTION

According to the invention, the linear actuator in the electric percussion tool has a rotor and a stator, wherein said rotor has at least one stack of superposed permanently magnetic bars. The stator is formed, at least partially, from a soft-magnetic material and has at least one pair of teeth with mutually opposed teeth, of which each pair of teeth receives a stack between them while forming an air gap in each case. The stator has at least two magnetically conductive inner regions which are arranged at a predetermined distance from one another in the direction of movement of the rotor and are at least partially surrounded, in each case, by an essentially hollow-cylindrical coil arrangement, the central longitudinal axis of which is oriented approximately transversely to the direction of movement of the rotor. In its simplest configuration, the rotor has a stack of superposed, permanently magnetic bars. Next to these at the side are arranged, on one side of the rotor, the coil arrangement on the stator and also the at least two magnetically conductive inner regions which are surrounded by the coil arrangements. In order to actuate a tool belonging to the electric percussion tool, the rotor has a driving element which interacts, via a loose coupling, with said tool belonging to the electric percussion tool in order to transmit a mechanical impulse to said tool.

In this connection, the invention has identified the fact that, with such an arrangement of the linear actuator, the two coil arrangements can be operated in such a way that the magnetic flux through one of the two magnetically conductive inner regions is essentially diametrically opposed, at any point in time, to the magnetic flux through the other magnetically conductive inner region. The overall arrangement consisting of the two coil arrangements with the appertaining stator arrangement thus forms, in combination with the permanently magnetic rotor bars, a self-contained magnetic circuit. In other words it is possible, in the case of the invention, for the magnetic flux induced in one direction by the one coil arrangement to be induced in the other direction at the same time by the other coil arrangement, so that the circuit is closed.

According to the invention, the rotor may have two or more stacks, which are arranged at a predetermined distance from one another, of permanently magnetic bars, and the magnetically conductive inner regions of the stator may be arranged between the stacks on the rotor.

Another concept which underlies the invention consists in “separating out” that part of the stator which brings about the circulation through the armature, namely the coil region with the stator coil arrangement, spatially from that part which forms the power of the linear actuator, namely the tooth region of the stator. By this means it is possible to achieve a considerably higher circulation through the armature, compared to conventional linear motors in which the stator coils are arranged between two teeth, in each case, on the stator. This is due to the fact that, because of the design according to the invention, the coil has considerably fewer spatial limitations and can thus be optimised to minimal (ohmic) losses—and an accompanying maximum magnetic field induction. The arrangement of the stator coil arrangement, whose central longitudinal axis is oriented transversely to the direction of movement of the rotor or, in other words, is essentially in alignment with the central longitudinal axis of two mutually opposed teeth belonging to a pair of teeth, is particularly efficient magnetically, since the magnetic flux induced by a coil oriented in this way flows equally through the pairs of teeth located at both end faces of the coil. An identical force is thereby generated in both stacks of permanently magnetic bars. This avoids oblique running of the rotor without any other special measures.

The invention also makes provision for the hollow-cylindrical coil arrangement to have an essentially rectangular cross-section, viewed along its central longitudinal axis M. A coil, which is essentially rectangular in its outer contour and has a clearance which is likewise essentially rectangular, thereby encloses the relevant magnetically conductive inner regions of the stator.

A pole pitch which is smaller than the size of the stator coil in its longitudinal direction is defined by the dimensions of the permanently magnetic bars in the direction of movement of the rotor, or by the dimensions of a tooth on the stator in the direction of movement of said rotor.

The rotor magnet pole/stator tooth arrangements which give rise to force or movement are likewise concentrated, so that they are not interrupted by stator coil arrangements. This permits a very small pole pitch which, in turn, brings about a high force density. Moreover, with the arrangement according to the invention, partial strokes of the rotor are possible.

Another essential advantage of the linear actuator according to the invention consists in the fact that it is practically only the magnetically active components (the permanent magnets) which contribute to the inert mass of the rotor, while all the other parts of the actuator (coils, magnetic short circuit, etc.) are allocated to the stator. It is thereby possible to achieve a particularly high ratio of force exerted by the actuator to inert mass.

Because of the arrangement, which can be very simple in design (a single-phase and hollow-cylindrical arrangement of, for example, rectangular cross-section), of the stator coil arrangements, it is possible to keep the influence of the jarring forces acting upon the coil very low, so that vibrations in the coil, or friction of the latter against the wall of the stator coil chamber, are low. It is thereby possible to manage with minimal material for insulating or lining the stator coil chamber. This also contributes to the compactness and reliability of the arrangement as a whole. Moreover, the simple construction brings about a high power density, even in the case of small linear actuators, since the achievable filling factor of the stator coil chamber (coil volume in said stator coil chamber, referred to the overall volume of the latter) is high.

According to the invention, each tooth may have, in the direction of movement of the rotor, a size which is essentially identical to the size of a permanently magnetic bar in the direction of movement of said rotor, so that, when said rotor is in a predetermined position, at least one pair of teeth on the stator is in alignment with one permanently magnetic bar in each case.

Pairs of teeth on the stator which are adjacent in the direction of movement of the rotor are preferably so dimensioned, relative to the size of the permanently magnetic bars in the direction of movement of said rotor, that at least one other of the permanently magnetic bars is arranged between two permanently magnetic bars which are in alignment with two mutually adjacent pairs of teeth on the stator.

According to the invention, the magnetically conductive inner regions may have at least one of the teeth at their ends that face towards the rotor. In the case of a rotor with two or more stacks, the magnetically conductive inner regions of the stator which are located between the two stacks have the teeth at their ends that face towards the stacks on the rotor.

Furthermore, the stator may have at least one magnetically conductive outer region which is located outside the stack on the rotor and has at least one of the teeth at its ends that face towards the stack on the rotor.

In the case of a rotor with two stacks, the stator may also have two magnetically conductive outer regions which are located outside the two stacks on the rotor and which have the teeth at their ends that face towards the stacks.

According to the invention, the externally located region of the stator is of essentially comb-shaped design in cross-section, at least in a partial section. In this case, the teeth on the comb form the outer (externally located) teeth of the pairs of teeth.

Adjacent bars in a stack have, according to the invention, an alternating magnetic orientation, the longitudinal axis of this orientation being essentially in alignment with the central longitudinal axis of two mutually opposed teeth belonging to a pair of teeth.

According to the invention, the central longitudinal axis of the coil arrangement may be oriented approximately transversely to the direction of movement of the rotor. It is likewise possible, according to the invention, for the central longitudinal axis of the coil arrangement to be approximately in alignment with the central longitudinal axis of two mutually opposed teeth belonging to a pair of teeth, or to be oriented essentially parallel to said axis, at least in certain sections. This permits an angled design of the inner regions of the stator, for example in order to obtain suitable space for mounting the coil arrangements.

In conformity with the invention, the predetermined distance between the two magnetically conductive inner regions may be so dimensioned that it is essentially identical to the size of an even number of permanently magnetic bars in the two stacks in the direction of movement of the rotor.

Two adjacent permanently magnetic bars, in each case, in the two stacks on the rotor may, according to the invention, be connected to one another at a predetermined distance by magnetically inactive spacers. These spacers may contain a light, magnetically inactive material (aluminium, titanium, plastic—including plastic with glass fibre or carbon fibre inclusions—or the like). As a result, the inert mass of the rotor is low, but its stability high.

Because of the dimensions of the permanently magnetic bars in the direction of movement of the rotor and the dimensions of the teeth on the stator in the direction of movement of said rotor, it is possible, according to the invention, to define a pole pitch which is smaller than the size of the stator coil arrangement in the direction of movement of said rotor.

The outer region(s) of the stator may, according to the invention, have at least one stator coil in addition to, or instead of, the inner regions of the stator.

The size of the coil arrangement on the stator in the direction of movement of the rotor may, according to the invention, be larger than the distance between two adjacent pairs of teeth on the stator.

On account of the path of the magnetic flux through the stator, which path is almost exclusively two-dimensional, said stator (the inner and/or outer magnetically conductive region) is preferably composed of parts made of electric sheets. However, it is also possible to manufacture it, at least partially, as a soft-magnetic shaped body, preferably made of pressed and/or sintered metal powder.

According to the invention, the outer regions of the stator form, at least partially, a magnetic short-circuiting body.

Because of the high power density of the arrangement according to the invention, the transverse dimensions of the linear actuator having the necessary power data can be kept very small. This permits its use in confined construction spaces.

The most diverse configurations are possible for the loose coupling of the linear actuator according to the invention to the tool belonging to the electric percussion tool for the purpose of transmitting the impact energy. Thus, for example, the driving element may be kinematically coupled to a striking part so as to be longitudinally displaceable in the direction of movement of the rotor, in such a way that said striking part is able to transmit the mechanical impulse to the tool belonging to the electric percussive tool essentially in the direction of movement of the rotor.

The coil arrangement of the stator may be set up so as to be supplied with current by an electronic control system in such a way that the driving element brakes its movement before the striking part impinges upon the tool or a tool-holder in the electric percussion tool, and said striking part covers a predetermined path in a free-floating phase. In this connection, “free-floating phase” is understood to mean a movement of the striking part in the direction of movement of the rotor, in which said striking part is not, or is virtually no longer, conveyed by the driving element onto the tool or a tool-holder in the electric percussion tool; rather, the striking part “floats” up to the tool or tool-holder as a result of a previous acceleration, which was exerted by the rotor on said striking part by means of the driving element, without any further driving-type coupling with the rotor. In other words, the striking part has disengaged itself from the driving part. As a result of the free-floating phase of the striking part, mechanical decoupling of the tool or tool-holder from the rotor of the linear actuator is achieved at the moment of impingement of said striking part upon said tool or tool-holder. The consequence of this loose coupling is that the individual components of the linear actuator, in particular its rotor, are not subjected to such high mechanical loadings.

Furthermore, the coil arrangement on the stator can be set up so as to be supplied with current by an electronic control system in such a way that the driving element moves the striking part towards the tool or a tool-holder in the electric percussion tool, and away from said tool or tool-holder and into the starting position again.

In order to actuate a tool belonging to the electric percussion tool, the rotor may also have a driving ram which interacts with a working chamber in which there is displaceably received a working piston which is set up so as to strike the tool belonging to the electric percussion tool, a working medium being located in said working chamber, between the driving ram and the working piston, so that, when the driving ram moves in the direction of movement of the rotor, the working piston performs a movement that corresponds thereto.

One difference between the arrangement according to the invention and the known arrangement of a breaking-up hammer described above is the fact that, as a result of using the linear actuator according to the invention, or of the loose coupling-up thereof to the tool belonging to the electric percussion tool, the components (transmission, crank mechanism with a pin on the latter, and connecting rod) which are necessary for converting the rotational movement of the alternating-current universal motor into a rectilinear movement are omitted.

Under these circumstances, the driving ram can project, at least in certain sections, into the working chamber which is of, for example, hollow-cylindrical design. Moreover, the working medium is preferably a compressible medium, for example air or some other gas; however, it is also possible to use a non-compressible medium, for example oil, water or the like. Finally, at least one stop may be provided, with which the working piston interacts in order to limit the movement of said piston in one or both directions of its movement.

The working piston may be arranged in the working chamber in such a way that the movement it performs is oriented approximately along the direction of movement of the rotor. However, it is also possible for the direction of movement of the rotor and the direction of movement of the working piston, or of the tool which belongs to the electric percussion tool and is connected to said piston, not to be co-linear but to form an angle with one another.

The energy is transmitted from the linear actuator to the working piston or the tool by the working medium between the driving ram and the working piston in the working chamber. Under these circumstances, mechanical decoupling of the working piston or the tool from the rotor of the linear actuator is achieved in the case of a compressible medium. The consequence of this decoupling is that the individual components of the linear actuator, in particular its rotor, are not subjected to such high mechanical loadings. If stronger coupling is desired, this can be achieved by using a non-compressible medium, it being possible to set said coupling, for example by means of a spring-loaded pressure-absorbing vessel.

Other features, properties, advantages and possible variations will be explained with the aid of the description that follows, in which reference is made to the appended drawings.

### BRIEF DESCRIPTION OF THE DRAWINGS

FIG. 1 illustrates, diagrammatically and in a longitudinal section in perspective, one form of embodiment of a linear actuator according to the invention in an electric percussion tool.

FIG. 1a illustrates, diagrammatically and in a longitudinal section in perspective, an alternative form of embodiment of a loose kinematic coupling of a striking part to the rotor.

FIG. 2 illustrates, diagrammatically and in a plan view in perspective, one form of embodiment of a coil arrangement belonging to the linear actuator according to the invention in the electric percussion tool.

FIG. 3 illustrates, diagrammatically and in a plan view in perspective, one form of embodiment of a stator belonging to the linear actuator according to the invention in the electric percussion tool.

FIG. 4 illustrates, diagrammatically and in a plan view in perspective, one form of embodiment of a stack of magnetic bars belonging to the linear actuator according to the invention in the electric percussion tool.

FIG. 5 illustrates, diagrammatically and in a longitudinal section in perspective, another form of embodiment of a linear actuator according to the invention in the electric percussion tool.

### DETAILED DESCRIPTION OF CURRENTLY PREFERRED FORMS OF EMBODIMENT

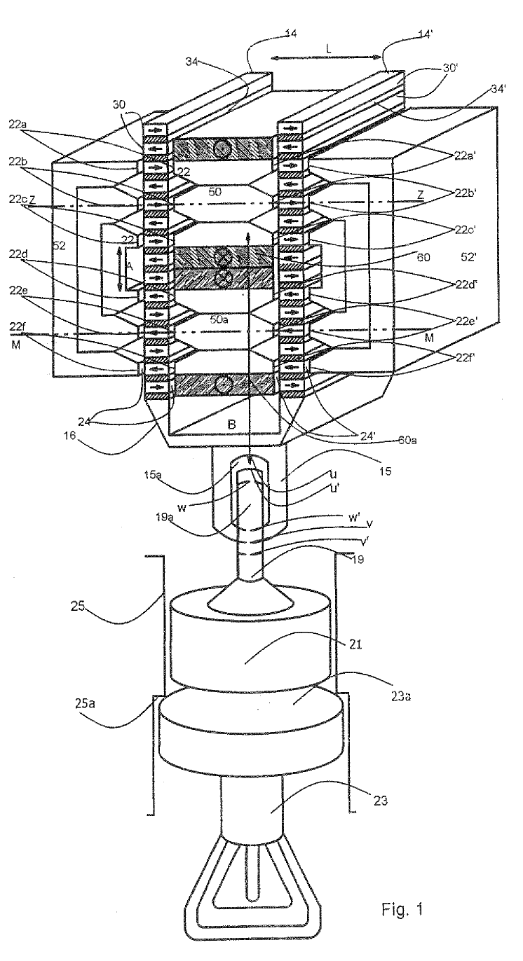

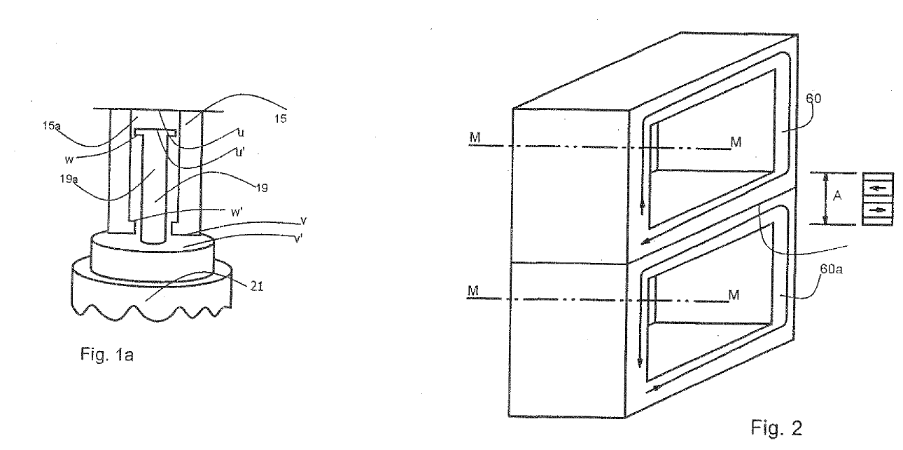

FIG. 1 illustrates a first form of embodiment of an electric linear actuator 10 in an electric percussion tool, which actuator has a rotor 16 and a stator 18. Those skilled in the art understand that the term “rotor” is used broadly to identify a moving element even though the motion is translational and or rotational. In the following description the rotor 16 translates and reciprocates along its axis.

The rotor 16 has two parallel stacks 14, 14′ which are arranged at a distance L from one another and consist of a large number of superposed permanently magnetic bars 30, 30′ having an essentially parallelepipedal design.

The stator 18 is in the form of a soft-magnetic shaped body made of sintered ferrous metal powder or of stratified iron laminations. The stator 18 has a number of pairs of teeth 22a, 22a′; 22b, 22b′; 22c, 22c′; 22d, 22d′; 22e, 22e′; 22f, 22f′ having mutually opposed teeth 22. One of the two stacks 14, 14′ is received, in each case, between the teeth 22 belonging to a pair of teeth, while forming an air gap 24 or 24′ respectively.

Between the two stacks 14, 14′ on the rotor 16, the stator 18 has magnetically conductive inner regions 50, 50a which are arranged at a predetermined distance A from one another in the direction of movement B of the rotor 16. Each of the two inner regions 50, 50a of the rotor 18 is surrounded by an essentially hollow-cylindrical coil arrangement 60, 60a in each case. The central longitudinal axis M of the respective coil arrangements 60, 60a extends approximately transversely to the direction of movement B of the rotor 16. The coil arrangement 60, 60a is embodied as a coil of copper tape in order to achieve the highest possible filling factor.

The two coil arrangements 60, 60a are to be loaded with current in such a way that they generate a magnetic field in the opposite direction in each case. In FIG. 1, the upper coil arrangement 60 generates, when the rotor 16 is in the position shown, a magnetic field which is essentially oriented along the central longitudinal axis of the coil arrangement 60 from left to right, while the lower coil arrangement 60a generates, when the rotor 16 is in the position shown, a magnetic field which is essentially oriented along the central longitudinal axis of the coil arrangement 60 from right to left. This changes in order to drive the rotor 16 (up or down) along the direction of movement B.

Since each coil arrangement 60, 60a completely surrounds, over its entire extension, the relevant region of the two inner regions 50, 50a of the stator 18, it can be filled up with the maximum winding space. As is illustrated in FIGS. 1 and 2 by means of suitable arrows—or rather points and ends of arrows—the two coil arrangements 60, 60a are to be supplied with current in such a way that they conduct current in the same direction, in each case, in the central section 64 in which they abut against one another (see FIG. 2).

In the arrangement shown, the rotor 16 is formed from two stacks 14, 14′ which are directed in a parallel manner and whose magnetic bars are formed from permanently magnetic material (for example samarium-cobalt). The individual magnetic bars 30 are superposed in a flush manner, their magnetic orientation being directed in an alternating manner (from the inner region of the stator 18 outwards, and vice versa). Moreover, the dimensions of the magnetic bars 30 are so designed that, when the rotor 16 is in a predetermined position, one of the magnetic bars 30 is in alignment between two teeth 22 belonging to a pair of teeth on the stator 18. Adjacent bars 30, 30′ in a stack 14, 14′ have an alternating N->S, S<-N magnetic orientation. When the rotor 14 is in certain positions, each of these bars is thereby in alignment with teeth 22 on the stator 18. In these positions of alignment, the central longitudinal axis Z of two mutually opposed teeth 22 belonging to a pair of teeth also essentially coincides with the magnetic orientation of the particular bar which is in alignment. As can be seen, the central longitudinal axis M of the coil arrangement 60 is also oriented approximately transversely to the direction of movement of the rotor 16 and is approximately in alignment with the central longitudinal axis of two mutually opposed teeth belonging to a pair of teeth.

In order to reduce the inert mass of the rotor 16, magnetically inactive spacers 34, 34′ made of plastic, for example carbon fibre-reinforced plastic, which are likewise parallelepipedal, are inserted between two adjacent magnetic bars 30 in a stack 14, 14′. The mutually adjacent permanently magnetic bars 30 and the magnetically inactive spacers 34, 34′ are fixedly connected to one another. In other words, the movable part of the actuator (the rotor) contains no parts (such as flux-conducting pieces for example) which conduct magnetic flux, but only permanent magnets which are always arranged in the optimum manner in the magnetic field. This arrangement also has the advantage of saving weight. If parallelepipedal bars made of permanently magnetic material are not available with sufficient magnetic field strength, it is also possible, according to the invention, to assemble the bars from permanent-magnet segments in such a way that a magnetic field which is directed (from the inside outwards or vice versa) is produced transversely to the direction of movement of the rotor 16.

The stator 18 also has two magnetically conductive outer regions 52, 52′ which are located outside the two stacks 14, 14′ on the rotor 16 and which are preferably manufactured as bundles of iron laminations on account of the guidance of magnetic flux, which guidance is almost exclusively two-dimensional. However, it is likewise possible to shape these in the form of soft-magnetic shaped bodies made of sintered ferrous metal powder. These externally located regions 52, 52′ of the stator 18 are of essentially comb-shaped design in cross-section and have, at their ends that face towards the stacks 14, 14′ on the rotor 16, teeth 22 which correspond in a mirror-inverted manner in their shape to the teeth of the internally located regions 50, 50a of the stator 18.

Located between the magnetically conductive inner regions 50, 50a is a predetermined distance A which is so dimensioned that it is essentially identical to the size of an even number (two in the form of embodiment shown) of permanently magnetic bars 30, 30′ in the two stacks 14, 14′ (with appertaining spacers) in the direction of movement B of the rotor 16. The length of the externally located regions 52, 52′ of the stator 18, which are of comb-shaped design in cross-section, is so dimensioned that corresponding teeth 22 at both ends, which face towards the magnetic bars on the rotor 16, lie opposite a magnetic bar of different orientation in each case. In other words, when the rotor is in a certain position, the teeth 22 belonging to the pair of teeth 22d are in alignment with an outwardly oriented magnetic bar, while the teeth 22 belonging to the corresponding pair of teeth 22c are in alignment with an inwardly oriented magnetic bar. The same applies, in a corresponding manner, to the teeth 22 belonging to the pair of teeth 22e, which correspond with the teeth 22 belonging to the pair of teeth 22b, and also to the teeth 22 belonging to the pair of teeth 22f, which correspond with the teeth belonging to the pair of teeth 22a. The outer regions 52 of the stator 18 thereby form a magnetic short-circuiting body. FIG. 1 illustrates the comb-shaped regions of the outer regions 52, 52′ of the stator 18 in the form of three individual C-shaped yokes which are fitted into one another. However, it is also possible to design the two outer regions 52, 52′ of the stator 18 as, in each case, a bundle of one-piece, soft-magnetic, comb-shaped laminations which are provided with the teeth in each case. An essential advantage of the arrangement, according to the invention, of the outer region(s) of the stator 18 lies in the fact that almost no stray magnetic flux is given off into the environment.

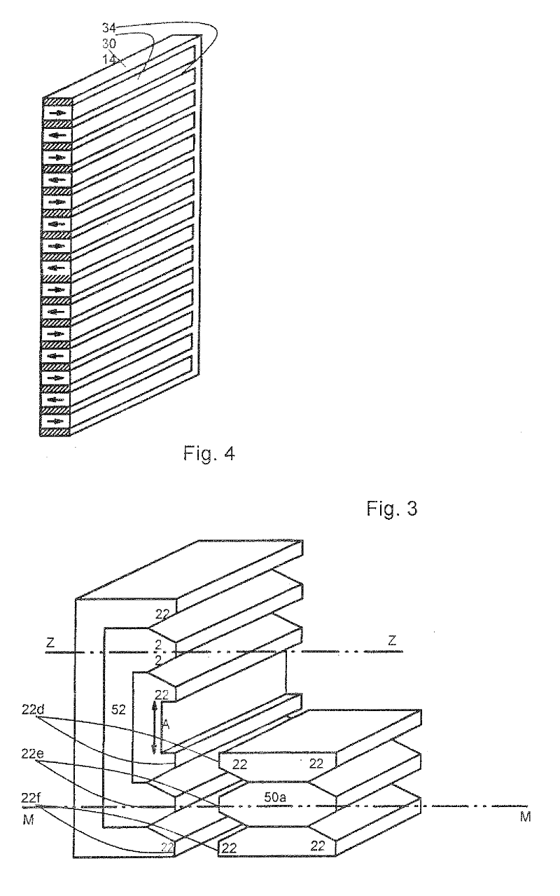

For the sake of clearer illustration, the stator 18 with its inner regions 50, 50a and outer regions 52, 52′ is shown in detached form in FIG. 3. In this figure, one of the outer regions 52′ and the upper inner region 50 have been omitted. What is not illustrated in the drawing, although it lies within the sphere of the invention, is that the outer regions 52, 52′ of the stator 18 have at least one stator coil in addition to, or instead of, the inner regions 52 of said stator 18. As can be seen, the size of the coil arrangement 60, 60a in the direction of movement of the rotor 16 is larger than the distance between two adjacent pairs of teeth on the stator 18.

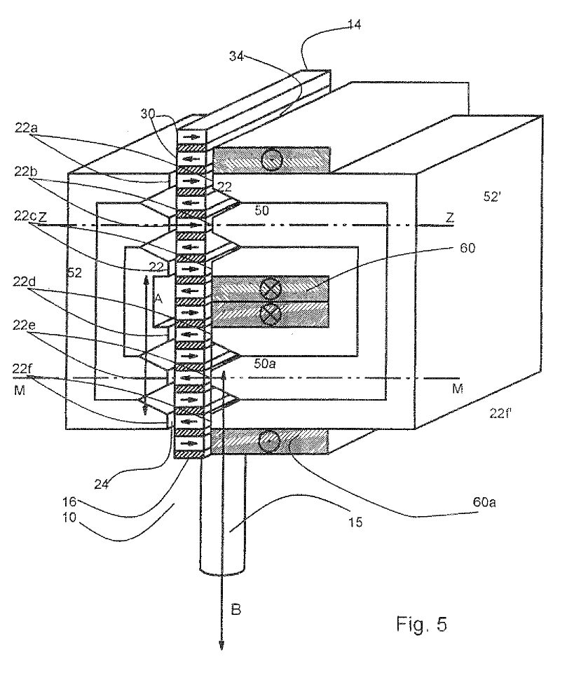

FIG. 5 illustrates a second form of embodiment of an electric linear actuator 10. In this case, reference symbols used in the previous figures denote parts or components having the same or a comparable function or mode of operation and are therefore explained again below only in so far as their actual configuration, function or mode of operation differs from what has been described above.

In this form of embodiment, the rotor 16 has a stack 14 consisting of a large number of superposed permanently magnetic bars 30 having an essentially parallelepipedal design. The stator 18 is in the form of a soft-magnetic stack of bundles of laminations. Said stator 18 has a number of pairs of teeth 22a . . . 22f with mutually opposed teeth 22. The stack 14 is received between the teeth 22 belonging to a pair of teeth, while forming an air gap 24 or 24′ respectively.

On one side of the stack 14 on the rotor 16 (the right-hand side in FIG. 5), the stator 18 has two magnetically conductive inner regions 50, 50a which are arranged at a predetermined distance A from one another in the direction of movement B of the rotor 16. Each of the two inner regions 50, 50a of the stator 18 is surrounded, in each case, by an essentially hollow-cylindrical coil arrangement 60, 60a. In practice, these two inner regions 50, 50a of the stator 18 form the legs of a reclining “U”, the connecting yoke of which is formed by a magnetically conductive outer region 52′. In other words, the second stack on the rotor is omitted in this form of embodiment, and the stator iron is shaped in a continuous manner. The externally located region 52 of the stator 18, which region lies outside the rotor 16, is of essentially comb-shaped design in cross-section and has, at its ends that face towards the stack 14 on the rotor 16, teeth 22 which correspond in a mirror-inverted manner in their shape to the teeth of the internally located regions 50, 50′ of the stator 18.

In this form of embodiment too, there is located, between the magnetically conductive inner regions 50, 50a, a predetermined distance A which is so dimensioned that it is essentially identical to the size of an even number (two in the form of embodiment shown) of permanently magnetic bars 30, 30′ in the two stacks 14, 14′ (with appertaining spacers) in the direction of movement B of the rotor 16. The length of the regions 52, 52′ of the stator 18, which are of comb-shaped design in cross-section, is likewise so dimensioned that corresponding teeth 22 at both ends, which teeth face towards the magnetic bars on the rotor 16, lie opposite a magnetic bar of different orientation in each case.

Linear actuators which are to be operated in a single-phase manner are described above. However, an arrangement of the linear actuator having two or more phases can also be designed within the sphere of the present invention. For this purpose, the teeth of another stator system with appertaining coils are to be positioned so as to be offset geometrically along the magnet of the rotor in a manner corresponding to the planned phase offset or offsets of the electrical driving power.

The rotor 16 has a rod-shaped driving element 15 which has a slot 15a at its free end (at the bottom in FIG. 1). Engaging in said slot 15a so as to be longitudinally displaceable in the direction of movement B of the rotor 16 is a bar 19 having a diametrically opposed slot 19a constructed at its free end (at the bottom in FIG. 1). Said bar 19 is connected to a circular-cylindrical striking part 21 made of high-tensile steel. By means of the two ends which catch in one another with their slots 15a, 19a, the striking part 21 is kinematically coupled to the rotor 16 in such a way that said striking part 21 is able to transmit a mechanical impulse in the direction of movement B to a tool belonging to the electric percussion hammer, which tool is indicated by the reference numeral 23.

Under these circumstances, a free end v of the driving element 15 and an inner point u on its slot 15a each bear, during a “thrust phase”, against an inner point v′ on the slot 19a of the bar 19 and against a free end u′ of said bar 19 respectively. A slowing-down or braking of the rotor 16 is then brought about by suitable activation of the coil arrangement on the stator 18, so that the thrust contact between the bar 19 and the driving element 15 is severed; the striking part is located in a “free-floating phase” in which it undergoes no further acceleration. The free-floating phase is terminated when the striking part 21 accelerated by the rotor 16 towards the tool 23 belonging to the electric percussion hammer impinges upon that end face 23a of the tool 23a which faces towards it. The tool 23 belonging to the electric percussion hammer is thereby accelerated in the direction of movement of the striking part 21 (downwards in FIG. 1). Said striking part 21 is then retracted again by the driving element 15 (upwards in FIG. 1), the respective opposed inner points w and w′ in the slots 15a and 19a bearing against one another for this purpose.

The tool 23 belonging to the electric percussion hammer and the striking part 21 are received at least partially—in a sliding fit—in a guide tube which is indicated by the reference numeral 25. The path of the tool 23 belonging to the electric percussion hammer is limited by a step 25a in said guide tube, so that, during the retraction of the striking part 21 from the tool 23, said part and tool are also separated from one another spatially in the direction of movement of the rotor 16. Instead of the stepped guide tube 25, however, other configuration are also possible, for example guide rails with corresponding path-limiting stops 25a for the tool 23 belonging to the electric percussion hammer.

Instead of the configuration illustrated in FIG. 1 of a loose kinematic coupling of the striking part 21 with the rotor 16 via the driving element 15 and the rod 19 by means of their ends which engage in one another, other forms of embodiment are also possible. To this end, FIG. 1a illustrates, in an exemplary manner, a loose coupling which likewise permits an acceleration of the striking part 21 by the rotor 16 towards the tool 23 or a tool-holder, a free-floating phase of said striking part 21 until it impinges upon the tool 23, and also a retrieval of said striking part 21 away from said tool 23. In this connection, components which are identical to those in FIG. 1 or operate in the same way bear identical reference numerals.

The coil arrangement on the stator 18 is connected electrically to an electronic control system, of which no further illustration is given, and is supplied with current by the latter in such a way that the rotor 16 brakes its movement before the striking part 21 impinges upon the tool 23 or a tool-holder in the electric percussion hammer, and said striking part 21 covers a predetermined path in a free-floating phase.

After the impulse has been transmitted by the striking part 21 to the tool 23 or tool-holder in the electric percussion tool, so that the tool performs an advance in the direction of movement, the coil arrangement 60, 60a may be supplied with current by an electronic control system in such a way that the rotor 16 draws the striking part 21 (back) in the opposite direction. In this case, the rotor 16 moves the striking part 21 up to the tool or tool-holder in the electric percussion tool at a first velocity, and away from said tool 23 or tool-holder at a second, lower velocity.

In another, likewise exemplary configuration of the loose coupling, the rotor may also be provided with a driving ram which projects into an essentially circular-cylindrical working chamber and is displaceable in the latter in a sliding manner through a seal in the sealing seat in the direction of movement of the rotor. Also located in the working chamber is a working piston which is likewise displaceable in a sliding manner in the direction of movement of the rotor. Said working piston is thereby able to strike against a tool belonging to the electric percussion tool, which tool is held in a tool-holder—for example by insertion, latching-in, etc. Located in the working chamber, between the driving ram and the working piston, is a working medium, for example in the form of air, so that, when said driving ram moves in the direction of movement B of the rotor, the working piston performs a corresponding—but cushioned—longitudinally directed ramming movement towards the tool-holder. In practice, the “air cushion” between the driving ram and the working piston pre-vents a direct reaction of a recoil of the tool towards the rotor.

The wall of the cylindrical working chamber may be provided with a step-shaped stop in order to limit the movement of the tool-holder, so that the working piston and the tool are spatially separated from one another in the direction of movement of the rotor during the retraction of the driving ram. Instead of a stepped tubular working chamber however, other configurations, for example guide rails with corresponding path-limiting stops for the tool belonging to the electric percussion tool, are also possible.

The forms of embodiment explained are particularly suitable for bringing about the stroke of the tool of about 10-200 mm which is called for, with the required individual impact energy of about 3 to about 150 joules and a number of impacts of about 150-3000 per minute in a relatively narrow construction space.

It is obvious to a person skilled in the art that individual aspects or features of the different forms of embodiment described above can also be combined with one another.

In the following claims reference numbers appear only for heuristic purposes and do not limit the scope of the claims to the referenced elements in the specification.

1. Linear actuator for an electric percussion tool, said actuator, comprising:
a rotor (16) and a stator (18), wherein
said rotor (16) has at least one stack (14, 14′) of superposed permanently magnetic bars (30, 30′),
the stator (18) is formed, at least partially, from a soft-magnetic material and has at least one pair of teeth (22a, 22a′; 22b, 22b′; 22c, 22c′; 22d, 22d′; 22e, 22e′; 22f, 22f′) with mutually opposed teeth (22), of which each pair of teeth receives a stack (14, 14′) between them while forming an air gap (24, 24′) in each case, and wherein
the stator (18) has at least two magnetically conductive inner regions (50, 50a) which are arranged at a predetermined distance A from one another in the direction of movement (B) of the rotor (16) and are at least partially surrounded, in each case, by an essentially hollow-cylindrical coil arrangement (60, 60a), the central longitudinal axis M of which is oriented approximately transversely to the direction of movement B of the rotor (16), and
the rotor (16) has a driving element (15) which interacts, via a loose coupling, with a tool (23) belonging to the electric percussion tool in order to transmit a mechanical impulse to said tool.

2. Linear actuator for an electric percussion tool according to claim 1, wherein the rotor (16) has two or more stacks (14, 14′), which are arranged at a predetermined distance from one another, of permanently magnetic bars (30, 30′), and the magnetically conductive inner regions (50, 50a) of the stator (18) may be arranged between the stacks (14, 14′) on the rotor (16).

3. Linear actuator for an electric percussion tool according to claim 1, wherein in that the hollow-cylindrical coil arrangement (60, 60a) has an essentially rectangular cross-section.

4. Linear actuator for an electric percussion tool according to claim 1, wherein each tooth (22) has, in the direction of movement (B) of the rotor (16), a size which is essentially identical to the size of a permanently magnetic bar (30, 30′) in the direction of movement (B) of said rotor (16), so that, when said rotor (16) is in a predetermined position, at least one pair of teeth on the stator (18) is in alignment with a permanently magnetic bar (30, 30′).

5. Linear actuator for an electric percussion tool according to claim 1, wherein pairs of teeth on the stator (18) which are adjacent in the direction of movement (B) of the rotor (16) are so dimensioned, relative to the size of the permanently magnetic bars (30, 30′) in the direction of movement (B) of said rotor (16), that at least one other of the permanently magnetic bars (30, 30′) is arranged between two permanently magnetic bars which are in alignment with two mutually adjacent pairs of teeth on the stator (18).

6. Linear actuator for an electric percussion tool according to claim 1, wherein the magnetically conductive inner regions (50, 50a) have at least one of the teeth (22) at their ends that face towards the rotor (16).

7. Linear actuator for an electric percussion tool according to claim 1, wherein the stator (18) has at least one magnetically conductive outer region (52) which is located outside the stack (14, 14′) on the rotor (16) and has at least one of the teeth (22) at its ends that face towards the stack (14, 14′) on the rotor (16).

8. Linear actuator for an electric percussion tool according to claim 1, wherein an externally located region (52, 52′) of the stator (18) is of essentially comb-shaped design in cross-section, at least in a partial section.

9. Linear actuator for an electric percussion tool according to claim 2, wherein adjacent bars (30, 30′) in a stack have an alternating magnetic orientation (N->S, S<-N), which is essentially in alignment with the central longitudinal axis (Z) of two mutually opposed teeth (22) belonging to a pair of teeth.

10. Linear actuator in an electric percussion tool according to claim 1, wherein the central longitudinal axis (M) of the coil arrangement (60) is oriented approximately transversely to the direction of movement of the rotor (16) or is approximately in alignment with the central longitudinal axis of two mutually opposed teeth belonging to a pair of teeth or is oriented essentially parallel to said axis, at least in certain sections.

11. Linear actuator in an electric percussion tool according to claim 1, wherein the predetermined distance (A) between the magnetically conductive inner regions (50, 50a) is so dimensioned that it is essentially identical to the size of an even number of permanently magnetic bars (30, 30′) in the two stacks (14, 14′) in the direction of movement (B) of the rotor (16).

12. Linear actuator in an electric percussion tool according to claim 2, wherein two adjacent permanently magnetic bars (30, 30′), in each case, in the two stacks (14, 14′) on the rotor (16) are connected to one another at a predetermined distance by magnetically inactive spacers (34, 34′).

13. Linear actuator in an electric percussion tool according to claim 2, wherein a pole pitch which is smaller than the size of the stator coil (28) in the direction of movement B of the rotor (16) is defined by the dimensions of the permanently magnetic bars (30) in the direction of movement (B) of the rotor (16) and by the teeth (22) on the stator (18).

14. Linear actuator in an electric percussion tool according to claim 1, wherein outer regions (52) of the stator (18) have at least one stator coil (28) in addition to, or instead of, the inner regions (52) of the stator (18).

15. Linear actuator in an electric percussion tool according to claim 1, wherein the size of the coil arrangement (60, 60a) in the direction of movement of the rotor (16) is larger than the distance between two adjacent pairs of teeth on the stator (18).

16. Linear actuator in an electric percussion toot according to claim 1, wherein the stator (18) is, at least partially, a soft-magnetic shaped body, preferably made of pressed and/or sintered metal powder.

17. Linear actuator in an electric percussion tool according to claim 1, wherein outer regions (52) of the stator form, at least partially, a magnetic short-circuiting body.

18. An electric percussion tool, comprising:
a linear actuator having
a rotor (16) and a stator (18), wherein
said rotor (16) has at least one stack (14, 14′) of superposed permanently magnetic bars (30, 30′),
the stator (18) is formed, at least partially, from a soft-magnetic material and has at least one pair of teeth (22a, 22a′, 22b, 22b′; 22c, 22c′; 22d, 22d′; 22e, 22e′; 22f, 22f′) with mutually opposed teeth (22), of which each pair of teeth receives a stack (14, 14′) between them while forming an air gap (24, 24′) in each case, and wherein
the stator (18) has at least two magnetically conductive inner regions (50, 50a) which are arranged at a predetermined distance A from one another in the direction of movement (B) of the rotor (16) and are at least partially surrounded, in each case, by an essentially hollow-cylindrical coil arrangement (60, 60a), the central longitudinal axis M of which is oriented approximately transversely to the direction of movement B of the rotor (16), and
the rotor (16) has a driving element (15) which interacts, via a loose coupling, with a tool (23) belonging to the electric percussion tool in order to transmit a mechanical impulse to said tool.
